(19) United States
(12) Patent Application Publication
(10) Pub. No.: US 2007/0147510 A1
(43) Pub. Date: Jun. 28, 2007

(54) Method and module for altering color space parameters of video data stream in compressed domain

(76) Inventors: Islam Asad, Richardson, TX (US); Fehmi Chebil, Irving, TX (US)

Correspondence Address: Hollingsworth & Funk, LLC, Suite 125, 8009 34th Avenue South, Minneapolis, MN, 55425, US

(21) Appl. No.: 11/319,026

(22) Filed: Dec. 27, 2005

(51) Int. Cl. H04N 11/04

(52) U.S. Cl. 375/240.18; 375/240.24

(57) ABSTRACT

The object of the present invention is to provide a methodology and a device for image processing (e.g. color toning) of a compressed video sequence, which overcomes the deficiencies of the state of the art. Particularly, the invention provides a solution for performing color-toning operations on H.263 and MPEG-4 videos in compressed domain.

### FIELD OF THE INVENTION

The present invention relates to the field of image processing of video data in the compressed domain and particularly to effective color-toning thereof.

### BACKGROUND OF THE INVENTION

Digital video cameras are increasingly spreading on the marketplace. The latest mobile phones are equipped with video cameras offering users the capabilities to shoot video clips and send them over wireless networks.

Digital video sequences are very large in file size. Even a short video sequence is composed of tens of images. As a result video is always saved and/or transferred in compressed form. There are several video-coding techniques that can be used for that purpose. H.263 and MPEG-4 are the most widely used standard compression formats suitable for low bit-rate wireless cellular environments. To allow users to generate quality video at their terminals, it is imperative that devices having video camera, such as mobile phones, provide video editing capabilities. Video editing is the process of transforming and/or organizing available video sequences into a new video sequence.

Video editing tools enable users to apply a set of effects on their video clips aiming to produce a functionally and aesthetically better representation of their video. To apply video editing effects on video sequences, several commercial products exist. However, these software products are targeted mainly for the PC platform.

Since processing power, storage and memory constraints are no longer the primary issue in the PC platform; the techniques utilized in such video-editing products operate on the video sequences mostly in their raw formats. In other words, the compressed video is first decoded, the editing effects are then introduced in the spatial domain, and finally the video is encoded again. This is known as spatial domain video editing operation.

The above scheme cannot be realistically applied on devices, such as mobile phones, that have low resources in processing power, storage space, available memory and battery power. Decoding a video sequence and re-encoding it are costly operations that take long time and consume a lot of battery power. Existing cameras on mobile phones are not comparable in performance to the most sophisticated digital cameras available in the market.

In the prior art, the video editing operation is performed in the spatial domain. More specifically, the video clip is first decompressed and then the operation is performed. The term video editing refers to any kind of editing operations like contrast and brightness adjusting or coloring, for instance. Finally, the resulting video sequences are re-encoded.

The major disadvantage of this approach is that it is significantly computationally intensive, especially the encoding part. Such a system cannot be realistically implemented on the mobile platform since it lacks the necessary architecture to process this kind of system in a practically viable manner. Most of the prior solutions operate in the spatial domain, which is costly in computational and memory requirements. Spatial domain operations require full decoding and encoding of the edited sequences, which are not practically feasible for mobile devices.

This present invention presents an efficient technique wherein the editing feature (coloring) is applied on the video in compressed domain, thereby making it a viable solution for use on mobile platforms.

### SUMMARY OF THE INVENTION

The object of the present invention is to provide a methodology and a device for image processing (particularly coloring, that is, altering color space parameters) of a compressed video sequence, which overcomes the deficiencies of the state of the art. Particularly, the invention provides a solution for performing color-toning operations and/or brightness/contrast adjustments on H.263 and MPEG-4 videos in compressed domain. Generally, color-toning is the process where the overall color of an image is changed by applying a color tone or color filter to it.

The objects of the present invention are solved by the subject matter defined in the accompanying independent claims.

According to a first aspect of the present invention, a method for altering color space parameters of a compressed video data stream is provided, the method comprising:
obtaining a compressed video data stream which is based on a domain transform and an intra-frame coding scheme;
detecting intra-coded blocks within said compressed video data stream;
determining coefficient values of said domain transform for said intra-coded blocks; and
modifying said coefficient values for performing said altering of said color space parameters.

This process is carried out in the compressed domain, so that less memory and CPU power is needed. According to the present invention said compressed video data stream is modified by modifying said coefficient values. Said modification may correspond to a color-toning operation, which means that the overall color of each frame (picture) of the video sequence will be set to a desired color. Further, it is conceivable that each picture of said video sequence may have another overall background color, but other combinations may be implemented within the scope of the present invention.

It is preferred that a compliant compressed video data stream with altered color space parameters is generated, that is, an altered video stream which is compliant to the format of the video stream before altering. That way interoperability can be ensured, both with hardware and software, as the altered video stream can be handled identically to the un-altered video stream.

Preferably said determining step is preceded by entropy decoding and de-quantization of said compressed video data stream, and said modifying step is succeeded by entropy coding and quantization of said compressed video data stream.

Preferably said compressed video data stream is an H.263 or an MPEG-4 video data stream. That is, said intra-frame coding scheme is H.263 or MPEG-4. Thus, compatibility of said method is guaranteed. Thereby other video compression techniques may also be deployed.

Conveniently, said compressed video data stream is based on a domain transform of an original video data stream. Said transform may correspond to a Discrete Cosine Transform (DCT), a wavelet transform, integer transform or the like. Other transforms may be applied within the scope of the present invention.

Preferably said modifying comprises modifying headers of said intra-coded blocks.

In an exemplary embodiment said transform coefficient values represent luminance parameters of said compressed video data stream, such that said altering of said color space parameters effects an adjustment of brightness and/or contrast of said compressed video data stream.

In an exemplary embodiment said coefficient values represent chrominance parameters of said compressed video data stream, such that said altering of said color space parameters effects an adjustment of the color tone of said compressed video data stream.

Preferably, said modifying of said coefficient values is based on changing macro block data of the frames representing said compressed video data stream. Accordingly, modifying on the macro block and block level within the DCT transformation of the original video sequence is possible.

Conveniently, said changing is based on changes carried out within the macro block header. Thereby, only the header may be changed and the data accompanying said header is unchanged.

According to another aspect of the present invention a computer program is provided. The computer program comprises program code sections stored on a computer readable medium for instructing a processor to carry out the steps of:
obtaining a compressed video data stream which is based on a domain transform and an intra-frame coding scheme;
detecting intra-coded blocks within said compressed video data stream;
determining coefficient values of said domain transform for said intra-coded blocks; and
modifying said coefficient values for performing said altering of said color space parameters.

According to yet another aspect of the present invention a module for color space parameters of a compressed video data stream is provided. The module comprises:
a component for obtaining a compressed video data stream which is based on a domain transform and an intra-frame coding scheme;
a component for detecting intra-coded blocks within said compressed video data stream;
a component for determining coefficient values of said domain transform for said intra-coded blocks; and
a component for modifying said coefficient values for performing said altering color space parameters.

Said module may be a software module using several components or modules to achieve the aforementioned functionality. Also an ASIC, FPGA or other conceivable programmable or full custom designed entities may be adapted to perform the steps of the methodology according to the present invention.

It is preferred that the module generates a compliant compressed video data stream with altered color space parameters, that is, an altered video stream which is compliant to the format of the video stream before altering. That way interoperability can be ensured, both with hardware and software, as the altered video stream can be handled identically to the un-altered video stream.

Preferably said module further comprises a component adapted for entropy decoding/entropy coding and de-quantization/quantization of said compressed video data stream.

Preferably said component for obtaining a compressed video data stream is adapted for obtaining an H.263 video stream or an MPEG-4 video stream.

Preferably said module further comprises a component for decompressing said compressed video data stream. Thus processing of a compressed video sequence or data stream, respectively, is possible.

Preferably said module further comprises a component for modifying headers of said intra-coded blocks.

Preferably said module further comprises a component for generating a compressed video data stream by applying a domain transform and intra-frame coding scheme to an original video data stream, wherein said domain transform comprises a Discrete Cosine Transformation (DCT) or a wavelet transformation, and said intra-frame coding scheme is H.263 or MPEG-4. Thereby a compressing functionality is achieved. This means that an original video sequence may be compressed within the module of the present invention.

According to yet another aspect of the present invention an electronic device is provided, adapted for altering color space parameters of a video data stream in compressed domain, comprising:
at least one module comprising
a component for obtaining a compressed video data stream which is based on a domain transform and an intra-frame coding scheme;
a component for detecting intra-coded blocks within said compressed video data stream;
a component for determining coefficient values of said domain transform for said intra-coded blocks; and
a component for modifying said coefficient values for performing said altering color space parameters.

The electronic device further comprises
an I/O interface;
a memory unit;
a communication interface; and
a CPU adapted for controlling all entities within said electronic device.

Said I/O interface preferably comprises a display, a keyboard, a touch screen or other means to interact with a certain user.

Furthermore said electronic device preferably corresponds to a mobile phone, a laptop, a notebook, a PDA, a personal computer, a consumer electronic entity, a digital camera (photo or video) or the like.

Advantages of the present invention will become apparent to the reader of the present invention when reading the detailed description referring to embodiments of the present invention, based on which the inventive concept is easily understandable.

Throughout the detailed description and the accompanying drawings same or similar components, units or devices will be referenced by same reference numerals for clarity purposes.

It shall be noted that the designations portable device and mobile device are used synonymously throughout the description.

### BRIEF DESCRIPTION OF THE DRAWINGS

The accompanying drawings are included to provide a further understanding of the invention, and are incorporated in and constitute a part of this specification. The drawings illustrate embodiments of the present invention and together with the description serve to explain the principles of the invention. In the drawings,

FIG. 1 illustrates conventional, prior art spatial domain color-toning process;

FIG. 2 shows a flow chart illustrating the methodology of color toning a compressed video stream according to the present invention;

FIG. 3 shows a color-toning process in accordance with the present invention;

FIG. 4 shows a module adapted for color-toning a compressed video stream, comprising several components;

FIG. 5 depicts a mobile device or a consumer electronic device, respectively according to the present invention;

FIG. 6 shows the procedure for performing color-toning operation in compressed domain according to an embodiment of the present invention;

FIG. 7 shows a procedure for setting INTRADC for U, V blocks for MPEG 4 sequences, according to an embodiment of the present invention; and

FIG. 8 shows a block X of an Intra MB along with its previous neighboring blocks used for DC prediction.

### DETAILED DESCRIPTION OF PREFERRED EMBODIMENTS

Video data consists of frames of images that capture a scene every few fractions of time units and give a sense of motion when played back continuously. For color video, each image frame consists of three color image components which, when combined, encompass the entire color gamut and give the effect of color images. Typically, an image frame is captured in RGB (Red/Green/Blue) color format. However, it contains a lot of color redundancy.

By its nature, video data is very large and causes major concerns in its storage and transmission. It is therefore natural to compress this data to a reasonable level. The first step in this compression process is to remove the color redundancy in the captured video. Color space conversion is therefore typically done from RGB color space to YUV 4:2:0 color space. This color conversion separates the three-component RGB color space into one luminance component and two chrominance components. The luminance component has the same size as the input image frame and is a manifestation of the gray-scale luminosity of the image. The chrominance components contain color information of the image and are not as sensitive to the human visual system. Each of them is therefore down-sampled by two in either spatial direction so that the combined YUV data is half of the RGB data. Additionally, this conversion results in the separation of the color components from the luminance component. Video data in YUV color space is then compressed using standardized compression techniques.

An overview of a typical video compression/decompression structure would help understanding the proposed technique: Video compression techniques exploit spatial redundancy in the frames forming the video. First, the frame data is transformed to another domain, such as the Discrete Cosine Transform (DCT) domain, to de-correlate it. The transformed data is then quantized and entropy coded.

In addition, the compression techniques exploit the temporal correlation between the frames: When coding a frame, utilizing the previous, and sometimes the future, frame(s) offers a significant reduction in the amount of data to compress.

The information representing the changes in areas of a frame can be sufficient to represent a consecutive frame. This is called prediction and the frames coded in this way are called predicted (P) frames or Inter frames. As the prediction cannot be 100% accurate (unless the changes undergone are described in every pixel), a residual frame representing the errors is also used to compensate the prediction procedure.

The prediction information is usually represented as vectors describing the displacement of objects in the frames. These vectors are called motion vectors. The procedure to estimate these vectors is called motion estimation. The usage of these vectors to retrieve frames is known as motion compensation.

Prediction is often applied to blocks within a frame. The block sizes vary for different algorithms (e.g. 8 by 8 or 16 by 16 pixels). Some blocks change significantly between frames, such that it is better to send all the block data independently from any prior information, i.e. without prediction. These blocks are called Intra blocks.

In video sequences there are frames which are fully coded in Intra mode, for example the first frame of the sequence since it cannot be predicted. Frames that are significantly different from previous ones, such as when there is a scene change, are also coded in Intra mode. The video encoder makes the choice of the coding mode.

The decoder operates on a multiplexed video bit-stream (includes video and audio), which is de-multiplexed to obtain the compressed video frames. The compressed data comprises entropy-coded-quantized prediction error transform coefficients, coded motion vectors and macro block type information. The entropy-decoded quantized transform coefficients c(x,y,t), where x,y are the coordinates of the coefficient and t stands for time, are inverse quantized to obtain transform coefficients d(x,y,t) according to the following relation:
d(x,y,t)=Q⁻¹(c(x,y,t)) (3)
where Q⁻¹ is the inverse quantization operation. In the case of scalar quantization, equation (3) becomes
d(x,y,t)=QPc(x,y,t) (4)
where QP is the quantization parameter. In the inverse transform block, the transform coefficients are subject to an inverse transform to obtain the prediction error E_{c}(x,y,t)
E_{c}(x,y,t)=T⁻¹(d(x,y,t)) (5)
where T⁻¹ is the inverse transform operation, which is the inverse DCT in most compression techniques.

If the block of data is an intra-type macro block, the pixels of the block are equal to E_{c}(x,y,t). In fact, as explained previously, there is no prediction, i.e.:
R(x,y,t)=E_{c}(x,y,t). (6)

If the block of data is an inter-type macro block, the pixels of the block are reconstructed by finding the predicted pixels positions using the received motion vectors (Δₓ,Δ_{y}) on the reference frame R(x,y,t−1) retrieved from the frame memory. The obtained predicted frame is:
P(x,y,t)=R(x+Δₓ,y+Δ_{y},t−1) (7)

The reconstructed frame is:
R(x,y,t)=P(x,y,t)+E_{c}(x,y,t) (8).

Video Editing is usually done by decoding the video sequence, applying the editing operations to it, and then re-encoding the edited video. The novelty of this invention is that it applies a special video editing effect (color-toning) to a video sequence while it is in compressed domain.

It is to be noted that, although the following will mainly concentrate on a color toning operation, the invention may as well be used for altering parameters as brightness and/or contrast, in a similar manner (that is, generally color space parameters). While the former is achieved by modifying the coefficient values representing chrominance data, the latter is achieved by applying similar modifications to coefficient values representing luminance data.

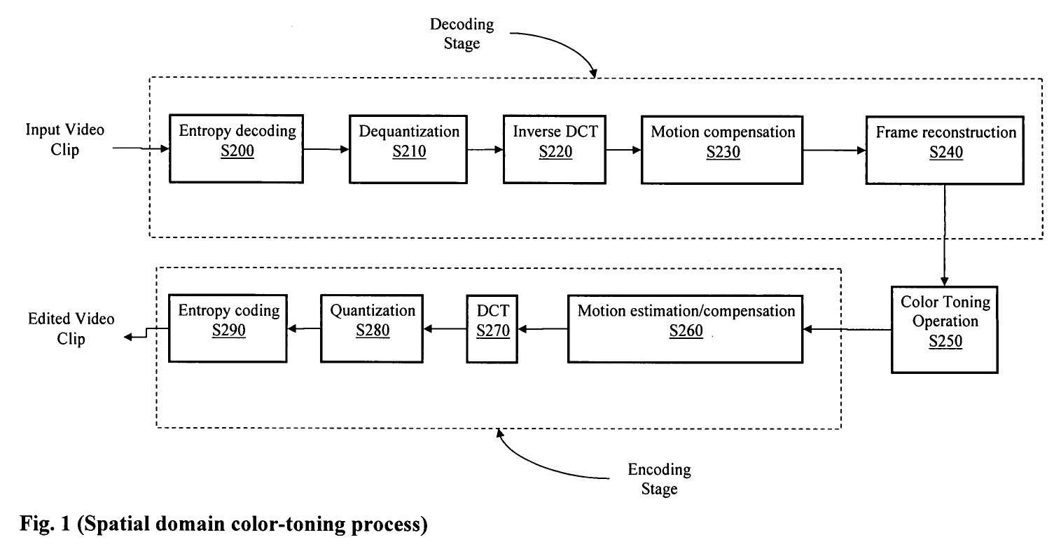

FIG. 1 shows applying the color-toning operation on a compressed video sequence using a conventional video editing system. As indicated above, it goes through the entire cycle of decode/encode. This operation is quite computationally complex, as the entire video sequence has to be fully decoded and re-encoded to achieve the desired results.

With reference to FIG. 1, a video adjustment system operating in the spatial domain is shown. The system has a usual DCT-transformed video clip as input and subsequently a number of operational blocks will be crossed, as shown in FIG. 1. The upper part of FIG. 1 generally symbolizes the decoding path and the lower path corresponds to the encoding process so that an edited video clip is provided at the output of said system. In this particular embodiment said edited video clip will be available also in DCT or compressed form, respectively.

In a video compression system, which is depicted with reference to the lower path according to FIG. 1, both temporal and spatial redundancies are exploited. To exploit the temporal redundancy, only the changes between the consecutive frames are encoded. The motion in the current frame is estimated or predicted from the previous frame. The motion compensated or predicted frame is then subtracted from the original frame.

The process of constructing the prediction is called motion compensation S230 and S260. In most video compression systems, motion compensation is block-based. More specifically, each frame is divided into blocks (called macro block) and a motion vector is assigned to each macro block. The motion vector of a macro block points to a block in the previous encoded frame, which is least different from that macro block. The process of finding these motion vectors is called motion estimation. The motion compensation process uses the previously determined motion vectors for image reconstruction or even for picture improvement, for instance. The motion compensation/estimation process is highly computational intensive, and consumes a large portion of processing time in the entire encoding process.

Spatial redundancy within a frame is exploited by applying transforms on the residual data. In a DCT-based video coding system, which is what most video compression standards use, 2D DCT transform is applied on 8×8 blocks. As a result of the DCT transform, pixel intensities are converted into DCT coefficients, which represent the energy distribution of the input block over spatial frequency. After DCT transform, the energy of the 8×8 block is highly concentrated in the low frequency coefficients while the high frequency coefficients are usually diminished. Therefore, only a few coefficients are needed to encode and transmit.

The DCT transform equation is shown below in principle and is depicted according to step S270:

$$Y ( n , m ) = \frac{1}{4} {C}_{n} {C}_{m} {\sum }_{j = 0}^{7} {\sum }_{j = 0}^{7} I ( i , j ) \cdot cos ( \frac{π \cdot n}{16} ( 2 i + 1 ) ) \cdot cos ( \frac{π \cdot m}{16} ( 2 j + 1 ) )$$

$${C}_{k} = \{ \begin{matrix}\frac{1}{\sqrt{2}} & k = 0 \\ 1 & k \neq 0\end{matrix}$$

where, i,j are the spatial coordinates of a pixel in a block, n, m are the frequency domain coordinates, I is the intensity of a pixel, Cₖ is the scaling factor, and Y(n,m) are the DCT coefficients. The lowest frequency coefficient Y(0,0) is called the DC coefficient and represents the mean intensity of the 8×8 block. The rest of the coefficients are called AC coefficients.

In the encoding process, which is depicted with reference to the lower path in FIG. 1, after applying the DCT transform on each 8×8 block S270, the DCT coefficients are quantized corresponding to an operation S280. After quantization, the number of non-zero DCT coefficients is further reduced (not depicted). The non-zero coefficients are entropy encoded S290 and transmitted or provided. However, a processed or edited video clip may now be further processed or stored.

In the decoding process, the reverse of the above operations (cf. encoding process) is performed. First, the bit streams are entropy decoded depicted with reference to an operation S200 and then the DCT coefficients are de-quantized as shown in an operation S210. The DCT coefficients are inverse transformed S220 to produce the residual frame. The residual is added to the reconstructed frame that is generated from the previous decoded frame to restore the uncompressed raw frame, corresponding to operations S230 and S240. Now a decoded video sequence in spatial domain may further be processed. In this exemplarily embodiment a color-toning video operation with reference to an operation S250 is provided. Said color-toning may comprise different coloring operations like sepia, blue, green or the like. Said adjusted video sequence in the spatial domain is used as input for the corresponding encoding or coding process to derive the previously mentioned edited video clip.

In the compression process, not all the blocks are coded with the residual information. Some blocks are coded with their original pixel values. This happens if, for example, the previous frame is not available or encoding the residual requires more bits than encoding the original frame. The encoding of the original pixel values is called Intra-coding, and the encoding of the residual pixel values is called Inter-coding.

Spatial domain color-toning conventionally requires fully decoding and re-encoding of video bit streams and it is highly complex since some computational intensive processes, such as motion compensation/estimation, have to be invoked.

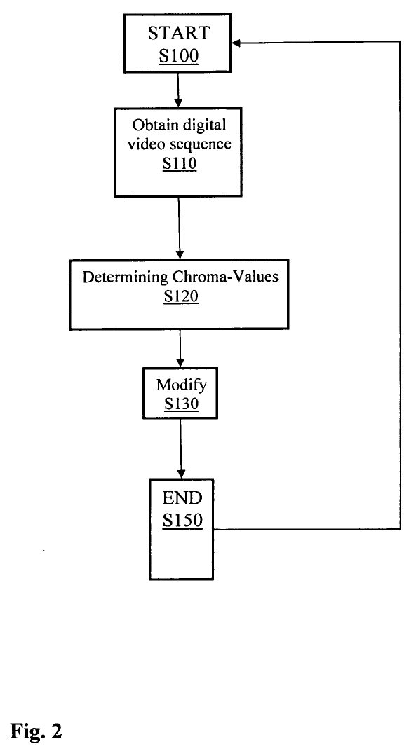

With reference to FIG. 2, a flow chart illustrating the principle of the methodology in accordance with the present invention is depicted. In an operation S100 the operational sequence starts. In accordance with the aforementioned description of the inventive concept a providing or obtaining, respectively of a compressed video sequence is performed which is shown with reference to an operation S110. Said sequence originates from an original sequence that is obtained by means of a video camera or the like. Also conceivable is that the video sequence was previously stored in a memory.

In an operation S120 determining of the chrominance values relating to said video sequence or stream is provided. The theoretical background of said determining operation will be described in detail in the following description. In an operation S130 modifying of said video sequence is provided. According to the present invention a color-toning operation is carried out, wherein said chrominance values are modified for obtaining the desired color of the compressed video sequence. The theoretical point of view on the coloring operation is given below. If no further processing is carried out the method comes to an end at operation S150 and may be restarted, which corresponds to a new iteration.

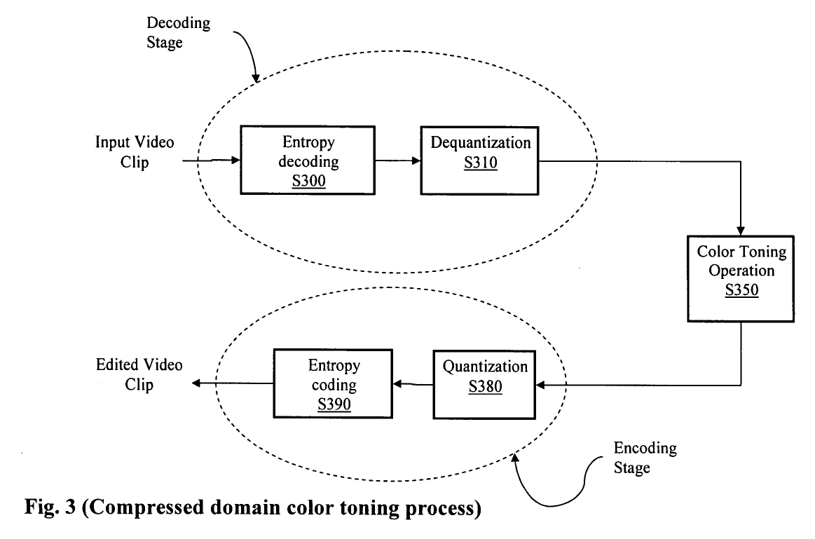

Spatial domain video enhancement that requires fully decoding and re-encoding video bit streams is highly complex since some computational intensive processes, such as motion compensation/estimation, have to be invoked. On the contrary, a compressed domain color-toning operation in accordance with the present invention manipulates the DCT coefficients, which avoid those complex processes. Therefore, substantial speedup can be achieved. This process or system is shown with reference to FIG. 3 describing an image processing system in compressed domain according to the inventive concept of the present invention.

The input video clip is a compressed (DCT-based) video sequence. In a first operation S300 entropy decoding is provided and subsequently a de-quantization operation S310 follows, as already described with reference to FIG. 1. The color-toning operation S350 according to the present invention is processed on the de-quantized coefficients resulting from the above-mentioned operation S310.

The coding path according to FIG. 3 (lower path) comprises the aforementioned operations as well: Quantization S380 and entropy coding S390. The result is an edited video clip, wherein the image processing was provided without any decompression steps in accordance with the advantage of the inventive concept of the present invention.

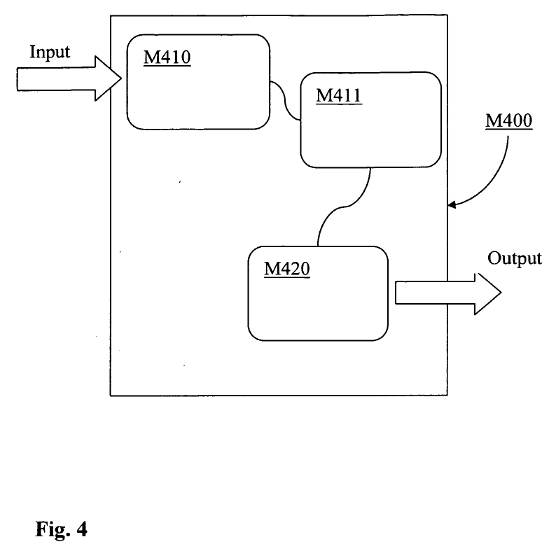

With reference to FIG. 4 a module M400 for color-toning of a compressed video sequence or stream, respectively is depicted. Said module comprises two main components: a component for providing (or obtaining) a compressed video sequence M410 and a component for performing an image processing operation (i.e. color-toning) M420 in accordance with the present invention. Both components are connected so that the output of M410 corresponds to the input of said image processing component M420. The component for providing M410 receives a video sequence represented by a digital data stream and is adapted for transforming the raw image data into a compressed video sequence. This data may be used as an input for M420, corresponding to the image processing component. In this particular embodiment there is an additional module M411 interconnecting M410 and M420. Said module M411 is adapted to determine the chrominance values included in the compressed video sequence. These values are further modified by means of said module M420 in accordance with the present invention.

After performing said image processing operation the data may be provided for further usage or stored in a memory component, for instance. The basis of the image processing module or component M420 has been previously described with reference to the accompanied figures (e.g. FIG. 3).

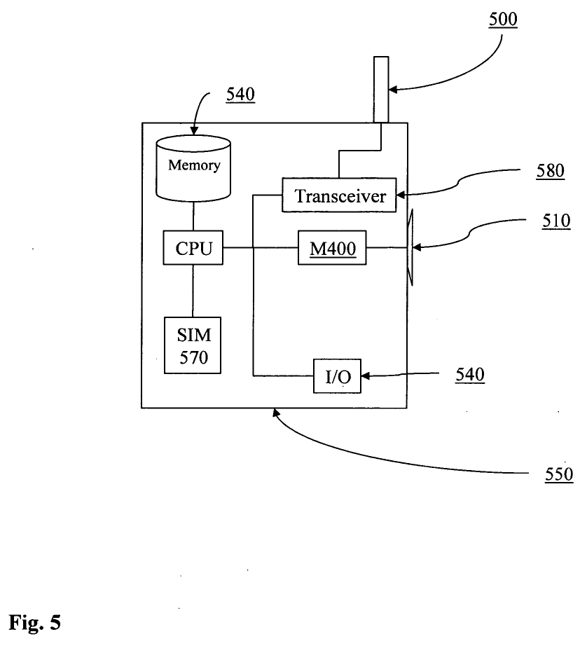

FIG. 5 illustrates principal structural components of a portable consumer electronic (CE) or a mobile device 550, respectively, which should exemplarily represent any kind of portable consumer electronic (CE) device employable with the present invention. It should be understood that the present invention is neither limited to the illustrated CE device 550 nor to any other specific kind of portable CE device.

The illustrated portable CE device 550 is exemplarily carried out as a camera phone, which designates typically a cellular phone with image and video clip capturing capability by the means of an image capturing sensor. In particular, the device 550 is embodied as a processor-based or micro-controller based device comprising a central processing unit (CPU), a data storage 520, an application storage (not shown), cellular communication means including cellular radio frequency interface (I/F) 580 with radio frequency antenna 500 and subscriber identification module (SIM) 570, user interface input/output means including audio input/output (I/O) means 540 (typically microphone and loudspeaker), keys, keypad and/or keyboard with key input controller (Ctrl) (not shown) and a display with display controller (Ctrl) (not shown), an image capturing sensor 510 including typically a CCD (charge-coupled device) sensor (not shown) with optics (not shown) for image projection, and an image processing module M400 (see also FIG. 4) representing exemplarily an implementation of several dependent and independent modules and components required for image handling in accordance with the present invention.

The operation of the CE device 550 is controlled by the central processing unit (CPU) typically on the basis of an operating system or basic controlling application controlling the features and functionality of the CE device by offering their usage to the user thereof. The display and display controller (Ctrl) are controlled by the central processing unit (CPU) and provides information for the user. The keypad and keypad controller (Ctrl) are provided to allow the user to input information. The information input via the keypad is supplied by the keypad controller (Ctrl) to the central processing unit (CPU), which may be instructed and/or controlled in accordance with the input information. The audio input/output (I/O) means 540 includes at least a speaker for reproducing an audio signal and a microphone for recording an audio signal. The central processing unit (CPU) may control the conversion of audio data to audio output signals and the conversion of audio input signals into audio data, where for instance the audio data have a suitable format for transmission and storing. The audio signal conversion of digital audio to audio signals and vice versa is conventionally supported by digital-to-analog and analog-to-digital circuitry.

Additionally, the portable CE device 550 according to a specific embodiment illustrated in FIG. 5 includes optionally the cellular interface (I/F) 580 coupled to the radio frequency antenna 500 and is operable with the subscriber identification module (SIM) 570. The cellular interface (I/F) 580 is arranged as a cellular transceiver to receive signals from the cellular antenna, decodes the signals, demodulates them and also reduces them to the base band frequency. The cellular interface 580 provides for an over-the-air interface, which serves in conjunction with the subscriber identification module (SIM) 570 for cellular communications with a corresponding base station (BS) of a radio access network (RAN) of a public land mobile network (PLMN). The output of the cellular interface (I/F) 580 thus consists of a stream of data that may require further processing by the central processing unit (CPU). The cellular interface (I/F) 580 arranged as a cellular transceiver is also adapted to receive data from the central processing unit (CPU), which is to be transmitted via the over-the-air interface to the base station (BS of the radio access network (RAN). Therefore, the cellular interface (I/F) 580 encodes, modulates and up converts the data embodying signals to the radio frequency, which is to be used. The cellular antenna then transmits the resulting radio frequency signals to the corresponding base station (BS) of the radio access network (RAN) of the public land mobile network (PLMN).

The image capturing sensor 510 is typically implemented by the means of a CCD (charge-coupled device) and optics. Charge-coupled devices containing grids of pixels are used for digital image capturing in digital cameras, digital optical scanners, and digital video cameras as light-sensing devices. An image is projected by optics (a lens or an arrangement of one or more lenses) on the capacitor array (CCD), causing each capacitor to accumulate an electric charge proportional to the light intensity at that location. A two-dimensional array, used in digital video and digital still cameras, captures the whole image or a rectangular portion of it. Once the array has been exposed to the image, a control circuit causes each capacitor to transfer its contents to its neighbor. The last capacitor in the array dumps its charge into an amplifier that converts the charge into a voltage. By repeating this process, the control circuit converts the entire contents of the array to a varying voltage, which it samples, digitizes, and provides the raw image data for further handling by the image processing module M400. The image processing module M400 enables the user of the CE device 550 to shoot still digital images and video sequences. Conventionally, the raw image data is compressed by the image processing module M400 and stored in the data storage. The image processing module M400 implements among others the codecs, i.e. coding and encoding modules required for still digital image processing and video (image sequence) processing, where the implemented components of the image processing module M400 are preferably software application components, which operation may be supported by specific hardware implementation, which is advantageous to improve processing capability and functionality of the image processing module M400.

Further, video data may be somehow captured or downloaded from a certain location and also conceivable is that the video data may be received for instance from a third party device.

As such, this invention provides significant amounts of speed-ups compared to the conventional approach for applying a color-toning effect, which is described in the following.

Color-toning is the process where the entire color of an image or frame is changed by applying a color filtering operation to it. This is done by appropriately adjusting the color primaries in the image to achieve the desired effect. These color primaries may be Red, Green and Blue if the color space is RGB. Video and image codecs usually deal with YUV 4:2:0 color space since it already compacts the raw data by half. In this color space, U and V are the color (chrominance) components. The aforementioned 4:2:0 color space shall serve as an example. However, the present invention may be applied to other color spaces like 4:4:4 or the like, for instance.

The 3-component (I₀,I₁,I₂)RGB color space can be transformed to the 3-component (Y₀,Y₁,Y₂) YUV color space by using the following irreversible color transformation:
Y₀=(0.299)I₀+(0.587)I₁+(0.144)I₂
Y₁=−(0.16875)I₀−(0.33126)I₁+(0.5)I₂
Y₂=(0.5)I₀−(0.41869)I₁−(0.08131)I₂ (9)

Conversely, the 3-component (Y₀,Y₁,Y₂) YUV color space can be transformed back to the 3-component (I₀,I₁,I₂) RGB color space by using the following inverse transformation:
I₀=Y₀+(1.402)Y₂
I₁=Y₀−(0.34413)Y₁−(0.71414)Y₂
I₂=Y₀+(1.772)Y₁ (10)

In order to apply color-toning for any color vector C in RGB space, the corresponding chrominance vector C′ in the YUV space can be computed by using eq. (9). The chrominance coefficients in the compressed bit stream can then be set to C′ in order to apply the color-toning effect.

By appropriately modifying the chrominance values, the color tone in the video sequence can be changed to any desired color. For example, the Sepia Color Effect can be achieved by forcing the U coefficients to a value of 100 and the V coefficients to 160. Other color effects were applied by choosing the appropriate value for the vector (U, V).

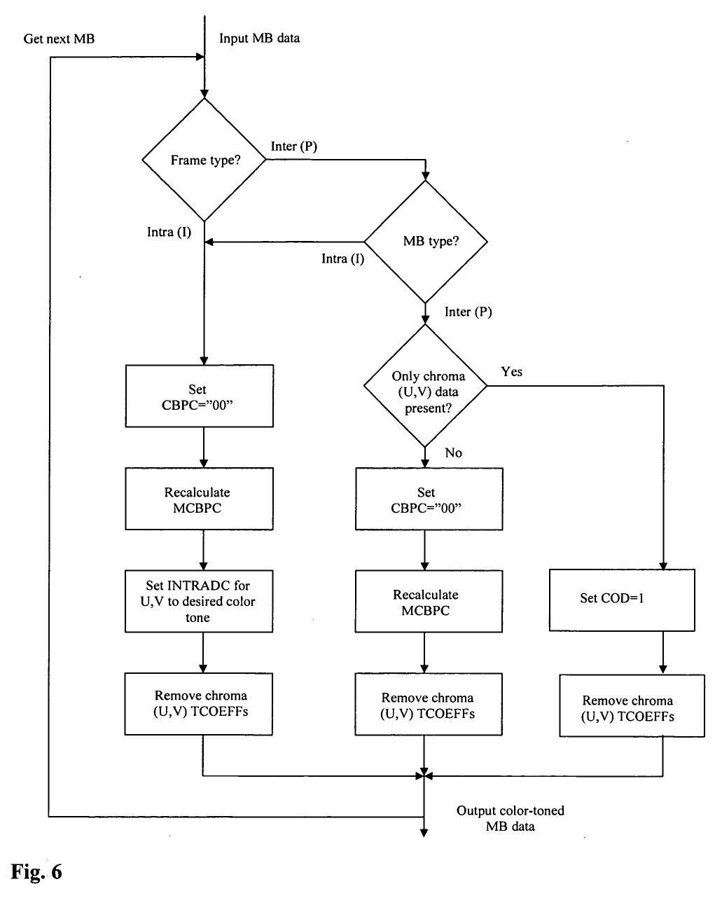

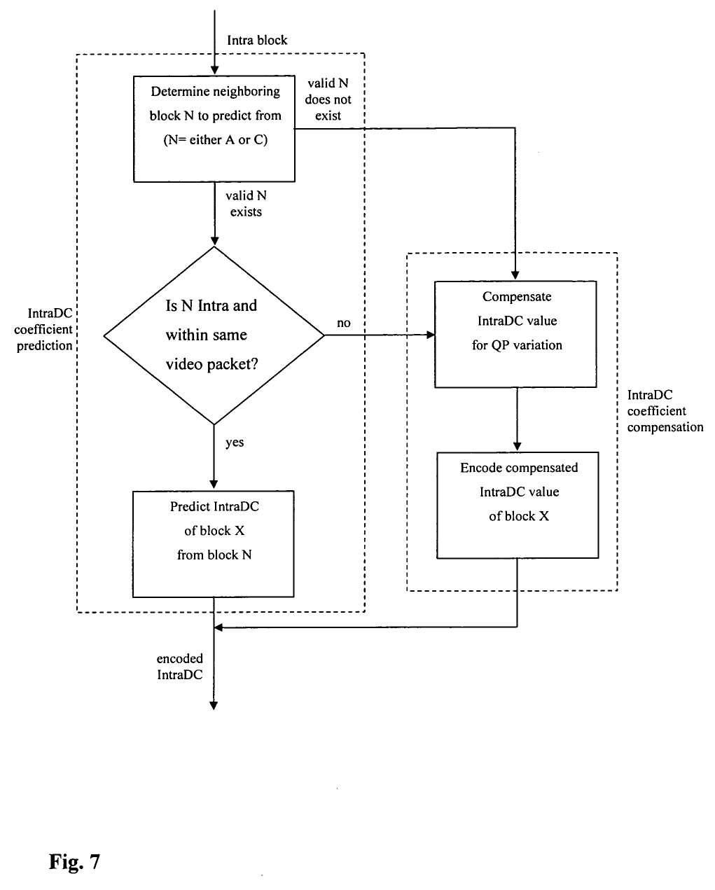

Referring to FIG. 6, the computation of IntraDC coefficients of chrominance blocks in an intra macro block requires sophisticated algorithms. In H.263, such IntraDC coefficients are simply encoded independently using a fixed length look-up table of codewords. For MPEG-4 the situation is much more complicated, such that the following additional operations are required (with reference to FIG. 7, FIG. 7 being a more detailed illustration of the step depicted in the box indicated in FIG. 6):

IntraDC Coefficient Prediction

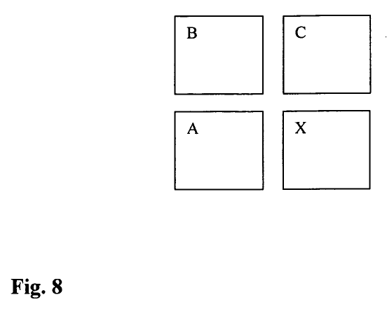

MPEG-4 uses DC coefficient prediction for intra macro blocks. The intraDC coefficient is predicted from its neighboring blocks (either A or C, cf. FIG. 8) depending on the horizontal and vertical DC gradients around the block X to be coded. Specifically,

| | |
|---|---|
| If(\| IntraDC_{A} − IntraDC_{B} \|<\| IntraDC_{B} − IntraDC_{C} \|) ′ | (9) |

Predict from block C

else

Predict from block A

IntraDC coefficient is only present in an intra macro block. So, if the neighboring block is not intra, then its IntraDC value is considered to be very high in the above equation so that its gradient is also very high. Also, if the neighboring block does not exist (because block X is at the top or left boundary) or belongs to a different video packet than the one for block X (prediction is only done within a video packet), then the intraDC value of that neighboring block is also considered to be very high. Valid blocks for prediction are intra macro blocks that exist as immediate neighbors (top, left, top-left) within the same video packet.

Once a neighboring block N has been established for prediction, then its intraDC coefficient is used for predicting the current block X's intraDC coefficient. The difference in the two values, i.e.,
δ=|IntraDC_{X}−IntraDC_{N}| (10)
is encoded. For uniform color toning, all the chrominance values must assume the same fixed value for the desired color tone. Hence, the codeword corresponding to the difference value δ=0 is coded.

Thus it is necessary to keep track of intraDC coefficients that will be predicted and those that will not be predicted. IntraDC coefficient for block X is predicted if all three of the following conditions are met:

Immediate neighboring block N exists

Block N is intra

Block N lies within the same video packet

IntraDC Coefficient Compensation

If the intraDC is not predicted, as will be the case if any of the above three conditions is not met, then the coefficient must be coded. However, the intraDC value for the block may not necessarily be the same over all the macro blocks of the frame. This is because the macro blocks may be coded with different Quantization Parameters (QP). De-quantization of a block of coefficients is dependent on the QP with which the block was coded. Different QPs will result in different reconstructed pixel values for the block even though the unquantized DCT coefficients are exactly the same.

Hence, in order to ensure that the reconstructed chrominance pixel values are the same for all the blocks in a frame, as they should be in a uniformly color-toned frame, the intraDC values of the various blocks must be adjusted in proportion to their QP values. Mathematically, the de-quantized intraDC coefficient is given by:
d(0,0,t)=Q⁻¹(c(0,0,t)) (11)

MPEG-4 uses scalar quantization for the block DC coefficients, which basically scales the coefficient by a scalar quantity—the DC scaler, i.e.,

$$d ( 0 , 0 , t ) = \frac{c ( 0 , 0 , t )}{DC\_scaler} \qquad ( 12 )$$

where the DC_scaler is defined as a non-linear scaler for the DC coefficients of chrominance DCT blocks, expressed in terms of Quantization Parameter (QP), as:

$$DC\_Scaler = \{ \begin{matrix}8 , for 1 \leq QP \leq 4 \\ ( QP + 13 ) / 2 , for 5 \leq QP \leq 24 \\ QP - 6 , for 25 \leq QP \leq 31\end{matrix} \qquad ( 13 )$$

It can be seen that the de-quantized intraDC coefficient d(0,0,t) is directly affected by the QP parameter with which the block (or macro block) is encoded. Hence, for the same set of unquantized DCT coefficients, if the QP changes, the de-quantized intraDC coefficient also changes. This means that in order to get the same de-quantized chrominance intraDC coefficient for all the blocks in a frame (which is what is needed for a uniform color toning operation), the unquantized chrominance intraDC coefficient, c(0,0,t), must be adjusted in accordance with the change in the QP of that block relative to a reference block. This reference block can be taken as the first chrominance block of the first frame.

For uniform color toning, the de-quantized intraDC coefficient of all chrominance blocks must be the same. If d_{R}(0,0,t) is the de-quantized intraDC coefficient of the reference chrominance block (say, first chrominance block of first frame), then all the rest of the de-quantized chrominance intraDC coefficients must have the same value. Hence, if d_{C}(0,0,t) is the de-quantized intraDC coefficient of the current chrominance block, then

$${d}_{C} ( 0 , 0 , t ) = {d}_{R} ( 0 , 0 , t ) \\ \frac{{c}_{c} ( 0 , 0 , t )}{{( DC\_scaler )}_{c}} = \frac{{c}_{R} ( 0 , 0 , t )}{{( DC\_scaler )}_{R}} \\ {c}_{c} ( 0 , 0 , t ) = {c}_{R} ( 0 , 0 , t ) \cdot ( \frac{{( DC\_scaler )}_{c}}{{( DC\_scaler )}_{R}} ) \qquad ( 14 )$$

where DC_scaler for current and reference blocks is computed using equation (13) with the QP values at which the current and reference blocks are encoded respectively. Equation (14) provides the compensated intraDC values that must be used to encode the chrominance intraDC coefficient in order to obtain uniform color toning in an MPEG-4 video sequence.
Brightness Adjustment

Brightness adjustment can be achieved in a similar manner by changing the intraDC coefficients of the luminance component of the original frame by a brightness adjustment step, Δ_{b}, If \tilde{c}(0,0,t) is the adjusted unquantized intraDC coefficient, then:
\tilde{c}(0,0,t)=c(0,0,t)+Δ_{b} (15)

Hence, the adjusted quantized intraDC coefficient is given by:

$$\tilde{d} ( 0 , 0 , t ) = \frac{\tilde{c} ( 0 , 0 , t )}{DC\_scaler} \\ \tilde{d} ( 0 , 0 , t ) = \frac{c ( 0 , 0 , t )}{DC\_scaler} + \frac{{Δ}_{b}}{DC\_scaler} \\ \tilde{d} ( 0 , 0 , t ) = d ( 0 , 0 , t ) + {\tilde{Δ}}_{b} \qquad ( 16 )$$

where,

$${\tilde{Δ}}_{b} = \frac{{Δ}_{b}}{DC\_scaler}$$

is the adjusted quantized brightness adjustment step.

Note that care must be taken to adjust for clipping of the coefficient values.

Contrast Adjustment

Contrast adjustment can be achieved in a similar manner by changing the intraDC coefficients of the luminance component of the original frame in accordance with the contrast adjustment step, Δ_{c}, where −1≦Δ_{c}≦1. If \tilde{c}(0,0,t) is the adjusted unquantized intraDC coefficient, and c̅(0,0,t) is the average unquantized intraDC coefficient of all the intra blocks of the frame, then:
\tilde{c}(0,0,t)=Δ_{c}·[c(0,0,t)− c̅(0,0,t)]+ c̅(0,0,t) (15)

The corresponding adjusted quantized intraDC coefficient can be written in the form:

$$\tilde{d} ( 0 , 0 , t ) = {Δ}_{c} \cdot d ( 0 , 0 , t ) + {\tilde{Δ}}_{c} \\ where , {\tilde{Δ}}_{c} = ( {Δ}_{c} - 1 ) \cdot \frac{\overline{c} ( 0 , 0 , t )}{DC\_scaler} . \qquad ( 16 )$$

Note that care must be taken to adjust for clipping of the coefficient values.

The invention relates to applying the color-toning effect in the compressed domain for the H.263 and MPEG-4 video formats. Both of these formats have a similar coding structure at the macro block level, which is the level where the chrominance DCT components will be modified. Hence, the same methodology for modifying the chrominance components will work for both H.263 and MPEG-4 video coding formats.

In order to implement the color-toning effect, there are changes required in the macro blocks of the frame. Specifically, the chrominance data for the individual macro blocks needs to be modified and the appropriate changes need to be made in the macro block header to reflect the data changes.

The following is the syntax of the macro block layer, along with its definitions.

| | | | | | |
|---|---|---|---|---|---|
| COD | MCBPC | CBPY | DQUANT | MVD | Block Data |

Coded macro block indication (COD) (1 bit): a bit which, when set to “0”, signals that the macro block is coded. If set to “1”, no further information is transmitted for this macro block. COD is only present in pictures that are not of type ‘INTRA’.

Macro block type & Coded Block Pattern for Chrominance (MCBPC) (Variable length): MCBPC is a variable length codeword giving information about the macro block type and the coded block pattern for chrominance. CBPC is a 2-bit codeword signifying if there are any DCT coefficients corresponding to U and V blocks.

Coded Block Pattern for luminance (CBPY) (Variable length): variable length codeword giving a pattern number signifying those Y blocks in the macro block for which at least one non-INTRADC transform coefficient is transmitted.

Quantizer Information (DQUANT) (2 bits/Variable Length): is a 2-bit codeword to define a change in QUANT (the quantization parameter in the range 1 to 31).

Motion Vector Data (MVD) (Variable length): MVD and MVD2-4 are present when indicated by MCBPC.

The following relates to the block layer for intra blocks. INTRADC always exists while TCOEFF exists when indicated by CBP (CBPY and MCBPC). There are 6 blocks within the macroblock layer—four blocks for luminance (Y) data, followed by two blocks of chrominance data (one each for U and V components).

The block layer syntax is:

| | |
|---|---|
| INTRADC | Tcoeff |

INTRADC: a codeword of 8 bits indicating the DC value of the block DCT.
TCoeff: VLC coded and Run-Length coded AC coefficients of the block DCT.

FIG. 6 illustrates the compressed domain processing required at the macro block bit stream level to perform the color-toning operation in accordance with the present invention.

Changes are required only at the macro block level of the compressed bit stream. The input to the system is one compressed macro block data. Variable-length decoding (VLC) is needed to bring the VLC-coded bit stream to a syntax that can be used for bit-level processing.

If the macro block (MB) belongs to an Intra (I) frame, then the MB itself is an Intra (I) MB. The CBPC field of this MB must be set to zero, indicating that the MB does not contain any coefficients for chrominance (U, V) components (except DC value). The corresponding variable length codeword (VLC) for this value must be computed and coded into the macro block, replacing the previous MCBPC value. The INTRADC value for U and V blocks in the MB are set corresponding to the chrominance value for the desired color tone. Finally, the DCT data in the Tcoeff field is removed for U and V blocks only. In short, all chrominance (U, V) data is removed from the macro block except the DC coefficient for the U and V blocks. The value of the DC coefficients is set to correspond to the desired color tone to reflect the color-toning operation.

If the MB belongs to a P-frame, then the MB itself may be either I- or P-MB. If it is I-MB, then the same procedure is applied as before. If it is P-MB, then there is no INTRADC field to set. The MVs apply to the Y blocks and do not need to change. Only the chrominance coefficients need to be removed. To reflect this change, the CBPC field of this MB must be set to zero, indicating that the MB does not contain any coefficients for chrominance (U, V) components. The corresponding variable length codeword (VLC) for this value must be computed and coded into the macro block, replacing the previous MCBPC value. Finally, the DCT data in the Tcoeff field is removed for U and V blocks only.

It is possible for a P-MB that the MB contains only chrominance data and no luminance (Y) data. This would be true if CBPY, MVD and DQUANT are all set to zero in the MB layer but still COD=1. In other words, there are no Y blocks coded, no motion vector data is coded and there is no change in QP of the macro block but still the macro block is coded. This indicates that there is chrominance data still coded in the MB layer. In this case also the chrominance data have to be removed and the header fields set accordingly. Specifically, the Tcoeff data for this MB is removed completely, and the COD field is set to one, indicating that this macro block is not coded.

The above approach takes care of all the possible cases for which the chrominance data must be removed and the corresponding changes made in the macro block header.

This invention is not limited to the above three editing operations of color toning, brightness and contrast adjustment. Rather, it can be applied to any editing effect that can be achieved by adjusting the intraDC coefficients of luminance and chrominance blocks, in a similar manner.

Even though the invention is described above with reference to embodiments according to the accompanying drawings, it is clear that the invention is not restricted thereto but it can be modified in several ways within the scope of the claims.

1. Method for altering color space parameters of a compressed video data stream, said method comprising:
obtaining a compressed video data stream which is based on a domain transform and an intra-frame coding scheme;
detecting intra-coded blocks within said compressed video data stream;
determining coefficient values of said domain transform for said intra-coded blocks; and
modifying said coefficient values for performing said altering of said color space parameters.

2. Method according to claim 1, wherein
said determining step is preceded by entropy decoding and de-quantization of said compressed video data stream; and
said modifying step is succeeded by entropy coding and quantization of said compressed video data stream.

3. Method according to claim 1, wherein said intra-frame coding scheme is H.263.

4. Method according to claim 1, wherein said intra-frame coding scheme is MPEG-4.

5. Method according to claim 1, wherein said domain transform comprises a Discrete Cosine Transform (DCT).

6. Method according to claim 1, wherein said domain transform comprises a wavelet transform.

7. Method according to claim 1, wherein said modifying comprises modifying headers of said intra-coded blocks.

8. Method according to claim 1, wherein said transform coefficient values represent luminance parameters of said compressed video data stream, and wherein said altering of said color space parameters adjusts brightness and/or contrast of said compressed video data stream.

9. Method according to claim 1, wherein said coefficient values represent chrominance parameters of said compressed video data stream, and wherein said altering of said color space parameters adjusts the color tone of said compressed video data stream.

10. Computer readable medium comprising program code sections stored thereon, for instructing a processor to carry out the steps of:
obtaining a compressed video data stream which is based on a domain transform and an intra-frame coding scheme;
determining intra-coded blocks within said compressed video data stream;
determining coefficient values of said domain transform for said intra-coded blocks; and
modifying said coefficient values for performing an altering of color space parameters of said compressed video data stream.

11. Computer readable medium according to claim 10, further comprising code sections stored thereon, for instructing a processor to carry out the steps of:
entropy decoding and de-quantization said compressed video data stream; and
entropy coding and quantization of said compressed video data stream.

12. Module for altering color space parameters of a compressed video data stream, said module comprising:
a component for obtaining a compressed video data stream which is based on a domain transform and an intra-frame coding scheme;
a component for detecting intra-coded blocks within said compressed video data stream;
a component for determining coefficient values of said domain transform for said intra-coded blocks; and
a component for modifying said coefficient values for performing said altering of color space parameters.

13. Module according to claim 12, further comprising a component adapted for entropy decoding/entropy coding and de-quantization/quantization of said compressed video data stream.

14. Module according to claim 12, wherein said component for obtaining a compressed video data stream is adapted for obtaining an H.263 video stream.

15. Module according to claim 12, wherein said component for obtaining a compressed video data stream is adapted for obtaining an MPEG-4 video stream.

16. Module according to claim 12, further comprising a component for decompressing said compressed video data stream.

17. Module according to claim 12, further comprising a component for modifying headers of said intra-coded blocks.

18. Module according to claim 12, further comprising a component for generating a compressed video data stream by applying a domain transform and intra-frame coding scheme to an original video data stream.

19. Module according to claim 18, wherein said domain transform comprises a Discrete Cosine Transformation (DCT).

20. Module according to claim 18, wherein said domain transform comprises a wavelet transformation.

21. Module according to claim 18, wherein said intra-frame coding scheme is MPEG-4.

22. Module according to claim 18, wherein said intra-frame coding scheme is H.263.

23. Electronic device, adapted for altering color space parameters of a compressed video data stream, comprising:
at least one module comprising
a component for obtaining a compressed video data stream which is based on a domain transform and an intra-frame coding scheme;
a component for detecting intra-coded blocks within said compressed video data stream;
a component for determining coefficient values of said domain transform for said intra-coded blocks; and
a component for modifying said coefficient values for performing said altering of said color space parameters;
and further comprising
an I/O interface;
a memory unit;
a communication interface; and
a CPU adapted for controlling all entities within said electronic device.

24. Electronic device according to claim 23, wherein said electronic device is a mobile phone, a PDA, a personal computer or a consumer electronic device.
